(19) United States
(12) Patent Application Publication
(10) Pub. No.: US 2010/0125850 A1
(43) Pub. Date: May 20, 2010

(54) Method and Systems for Processing Critical Control System Functions

(76) Inventors: Harold Stevenson Hostettler, Edinboro, PA (US); Wolfgang Daum, Erie, PA (US); John Hershey, Ballston Lake, NY (US)

Correspondence Address: Armstrong Teasdale LLP (12729 +2000);John S. Beulick, ONE METROPOLITAN SQUARE, Suite 2600, SAINT LOUIS, MO, 63102-2740, US

(21) Appl. No.: 12/274,825

(22) Filed: Nov. 20, 2008

(51) Int. Cl. G06F 9/46; G06F 13/24; G06F 13/00

(52) U.S. Cl. 718/103; 718/104; 710/260; 710/100

(57) ABSTRACT

A method for processing critical control system functions is described. The method includes determining a level of criticality of at least one data packet and directing critical data packets to at least one of a critical computational job queue and a critical memory portion. The method also includes directing non-critical data packets to at least one of a non-critical computational job queue and a non-critical memory portion and executing control system functions corresponding to critical data packets stored in the critical computational job queue. The method also includes executing control system functions corresponding to non-critical data packets stored in the non-critical computational job queue when no critical control system functions are stored in the critical computational job queue.

### BACKGROUND OF THE INVENTION

The field of the invention relates generally to locomotive control system functions, and more specifically, to isolation of critical functions from non-critical functions of the locomotive control system within a computational platform.

A locomotive control system may include multiple system processors. Typically, one system processor, and corresponding computing hardware, is designated to perform critical functions of the locomotive control system. Additionally, a separate system processor, and corresponding computing hardware, is designated to perform non-critical functions of the locomotive control system. For example, a critical function in some locomotives is monitoring and control of emissions. In order for the locomotive to operate within the laws of certain countries, emissions must be within a defined range. Due to the importance of critical functions, a higher level of proof of proper operation is chosen than is used to test for proper operation of non-critical functions. More specifically, functions may be assigned a level of proof that corresponds to a predetermined criticality of the function. For example, the level of proof for critical functions may include receiving positive proof that the critical functions are properly operating. The level of proof for a non-critical function may include proving the function is not properly operating, or in other words, operation of a non-critical function may be permitted without positive proof that the function is operating properly. Furthermore, in contrast to critical functions, non-critical functions may operate acceptably in a degraded state.

Although critical functions may be a small subset of overall locomotive control system functions, they are a critical subset. Isolation of critical functions from the rest of the locomotive functions facilitates providing the treatment of the critical functions needed for proof positive of proper operation. However, to host a separate computer on-board a locomotive specifically for critical function computations requires significant additional cost and communications overhead.

### BRIEF DESCRIPTION OF THE INVENTION

In one aspect, a method for processing critical control system functions is provided. The method includes determining a level of criticality of at least one data packet and directing critical data packets to at least one of a critical computational job queue and a critical memory portion. The method also includes directing non-critical data packets to at least one of a non-critical computational job queue and a non-critical memory portion and executing control system functions corresponding to critical data packets stored in the critical computational job queue. The method also includes executing control system functions corresponding to non-critical data packets stored in the non-critical computational job queue when no critical control system functions are stored in the critical computational job queue.

In another aspect, a vehicle control system is provided. The vehicle control system includes at least one module coupled to a communication bus. The at least one module is configured to generate data packets and transmit the data packets onto the communication bus. The vehicle control system also includes a critical function firewall coupled to the communication bus. The critical function firewall is configured to: determine a level of criticality of each data packet received from the communication bus, and direct each data packet according to the level of criticality. The vehicle control system also includes a computer system coupled to the critical function firewall and configured to process each data packet in accordance with the corresponding level of criticality.

In yet another aspect, a critical function management system for managing critical functions of a vehicle control system is provided. The critical function management system includes a computer system comprising a memory unit and a processor. The memory unit includes a first memory portion and a second memory portion. The critical function management system also includes a critical function firewall coupled between a communication bus and the computer system. The critical function firewall is configured to: determine a criticality of received data packets, direct requests to input critical data into the memory unit to the first memory portion, and store requests for critical computational jobs in a critical computational job queue.

### BRIEF DESCRIPTION OF THE DRAWINGS

FIG. 1 is a partial cut away view of an exemplary locomotive.

FIG. 2 is a block diagram of an exemplary embodiment of the train control system shown in FIG. 1.

FIG. 3 is a block diagram of an exemplary embodiment of a data packet.

FIG. 4 is a block diagram of an exemplary embodiment of a train control system that includes a critical function firewall.

FIG. 5 is a flowchart of an exemplary method for processing critical control system functions.

### DETAILED DESCRIPTION OF THE INVENTION

The following detailed description illustrates embodiments of the invention by way of example and not by way of limitation. Although described herein pertaining to locomotives, it is contemplated that the invention has general application to vehicle control systems, including vehicles other than locomotives, in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

As used herein, the terms “vital” and “critical” are used interchangeably. For example, vital functions, and critical functions, are functions that are designated by an operator of a locomotive to be of greater importance to the operation of the locomotive than non-critical functions.

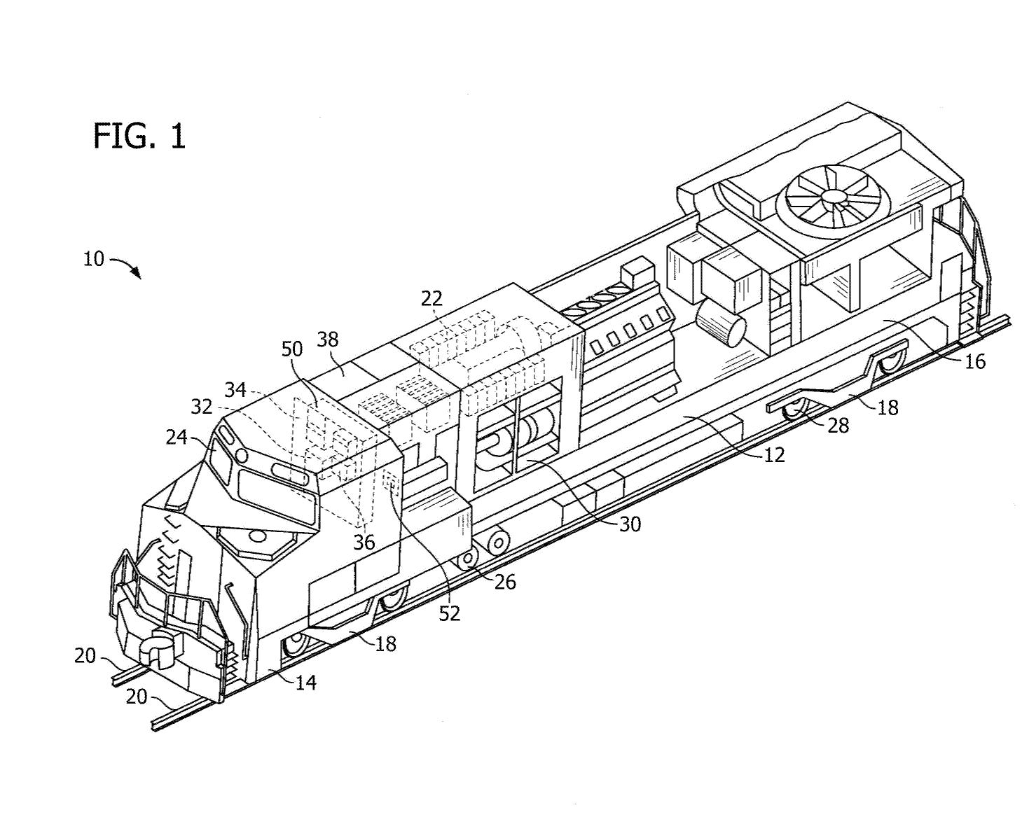

FIG. 1 is a partial cut away view of an exemplary locomotive 10. Locomotive 10 includes a platform 12 having a first end 14 and a second end 16. A propulsion system 18, or truck is coupled to platform 12 for supporting, and propelling platform 12 on a pair of rails 20. An equipment compartment 22 and an operator cab 24 are coupled to platform 12. An air and air brake system 26 provides compressed air to locomotive 10, which uses the compressed air to actuate a plurality of air brakes 28 on locomotive 10 and railcars (not shown) behind it. An auxiliary alternator system 30 supplies power to all auxiliary equipment. An intra-consist communications system 32 collects, distributes, and displays consist data across all locomotives in a consist.

A cab signal system 34 links the wayside (not shown) to a train control system 36. In particular, system 34 receives coded signals from a pair of rails 20 through track receivers (not shown) located on the front and rear of the locomotive. The information received is used to inform the locomotive operator of the speed limit and operating mode. A distributed power control system 38 enables remote control capability of multiple locomotive consists coupled in the train. System 38 also provides for control of tractive power in motoring and braking, as well as air brake control. Locomotive 10 systems are monitored by an on-board monitor (OBM) system 50. OBM system 50 keeps track of incidents occurring in the systems with an incident log. An operator display system 52 provides an operator with graphical, textual, and/or aural information regarding the status and operation of locomotive 10 and associated rolling stock (not shown) as well as track conditions, operating limits and instructions. Operator display system 52 may include information of a critical nature.

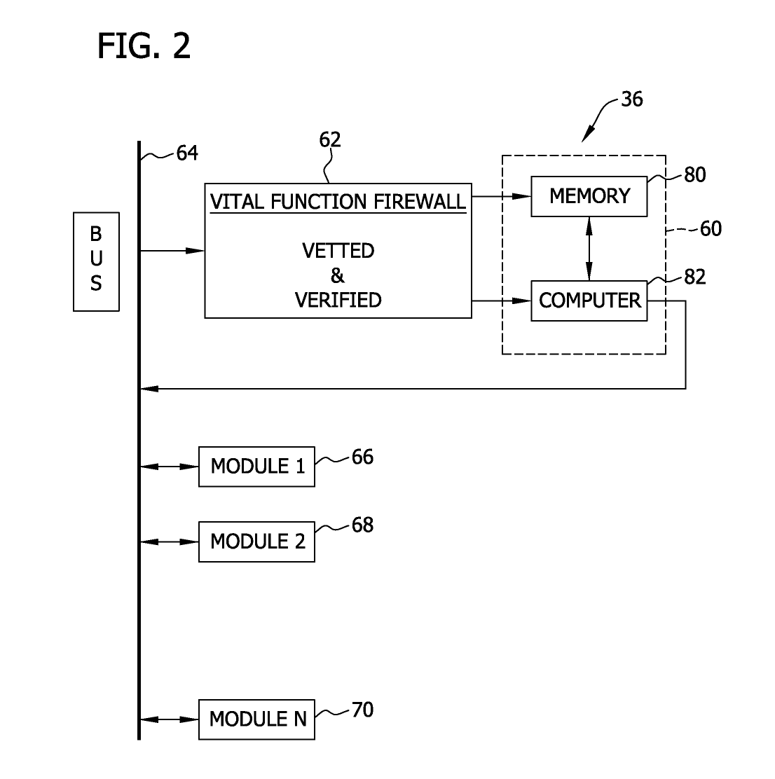

FIG. 2 is a block diagram of an exemplary embodiment of train control system 36 (shown in FIG. 1). Train control system 36 includes a computer system 60, a critical function firewall 62, a communication bus 64, and a plurality of modules, for example, a first module 66, a second module 68, and a third module 70. Modules 66, 68, and 70 are coupled to communication bus 64. Critical function firewall 62 is also coupled to communication bus 64. Critical function firewall 62 is coupled to computer system 60. In the exemplary embodiment, modules 66, 68, and 70 are sensors that generate data packets that are transmitted over communication bus 64. Although described as sensors, modules 66, 68, and 70 may be other types of individual hardware systems including sensors, systems, actuators, or data interfaces to other systems. Also, although described as including three modules, control system 36 may include any number of modules. Each of modules 66, 68, and 70 are capable of originating and receiving data messages that are respectively put onto and taken off of communication bus 64.

In the exemplary embodiment, computer system 60 includes a memory unit 80 and a processor 82. Memory unit 80 and processor 82 are coupled such that data may flow in both directions between memory unit 80 and processor 82. Data from communication bus 64 may flow through critical function firewall 62 and into computer system 60. In the exemplary embodiment, critical function firewall 62 is implemented by either hardware interfaces or software interfaces, and facilitates segregating train control system 36 functions. Critical function firewall 62 may also be implemented by a combination of hardware interfaces and software interfaces. Data from computer system 60 may flow onto communication bus 64.

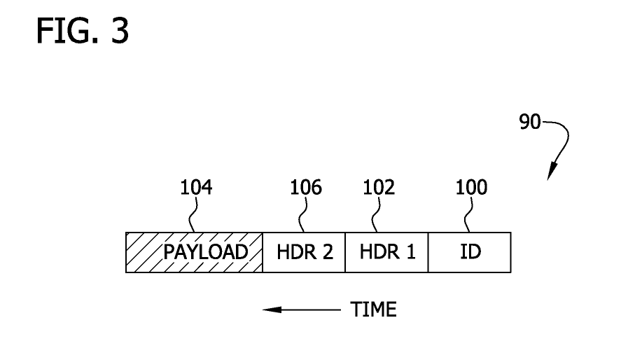

FIG. 3 is a block diagram of an exemplary embodiment of a data packet 90. As described above, data packet 90 is generated by one of the plurality of modules 66, 68, and 70, or by computer system 60. Data packet 90 carries a data message. There are many possible data packet structures known in the art. By way of example, and not limitation, data packet 90 includes an identification field 100. Identification field 100 identifies the origin of data packet 90. Data packet 90 also includes a first header field 102. In the exemplary embodiment, first header field 102 specifies an intended recipient of data packet 90. In the exemplary embodiment, data packet 90 also includes a payload field 104 that may, by way of example and not limitation, contain data from a sensor, a computational result, a functional request, and/or programming related information. Data packet 90 may also include a second header field 106 that specifies whether the data in payload field 104 is critical.

In the exemplary embodiment, data packets 90 may be managed according to a variety of data protocols. The data protocol, for example and not by way of limitation, may require an acknowledgment be sent to an originator of data packet 90 upon receipt of data packet 90 by the data packet's addressee.

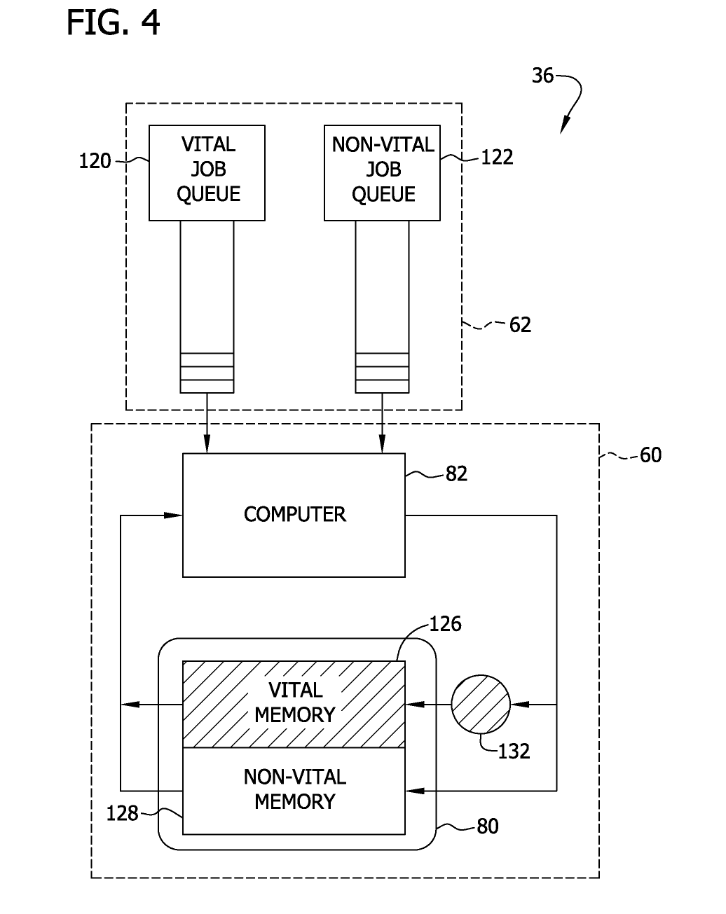

FIG. 4 is an expanded view of train control system 36, which is also shown in FIG. 2. In an exemplary embodiment, train control system 36 includes critical function firewall 62. In an exemplary embodiment, critical function firewall 62 includes a critical computational job queue 120 and a non-critical computational job queue 122. Critical job queue 120 and non-critical job queue 122 store job requests received, in data packets, at critical function firewall 62 until processor 82 is able to execute the jobs. In the exemplary embodiment, critical function firewall 62 is configured to determine if a data packet is critical or non-critical. If the data packet includes a request for a critical computational job, critical function firewall 62 directs the data packet to critical computational job queue 120. If the data packet includes a request for a non-critical computational job, critical function firewall 62 directs the data packet to non-critical job queue 122.

In an exemplary embodiment, when processor 82 is ready to begin a new job, processor 82 is configured to first check critical job queue 120. If there is a job stored in critical job queue 120, processor 82 executes that job. If there are no jobs stored in critical job queue 120, processor 82 is configured to check non-critical job queue 122 and execute a job stored in non-critical job queue 122. In some embodiments, processor 82 may be configured to interrupt execution of a non-critical job and begin execution of a critical job when critical function firewall 62 determines a critical job has been received and places the critical job in critical job queue 120.

In an exemplary embodiment, memory 80 is sectioned into at least two portions, for example, a critical memory portion 126 and a non-critical memory portion 128. In an exemplary embodiment, critical function firewall 62 controls a firewall memory switch 132. As described above, critical function firewall 62 receives data packets from communication bus 64 (shown in FIG. 2). If critical function firewall 62 determines that the data packet is critical, and the data packet includes a request to input critical data into memory 80, critical function firewall 62 is configured to instruct switch 132 to allow the data packet into critical memory portion 126. If critical function firewall 62 determines that a data packet includes a request to input non-critical data into memory 80, critical function firewall 62 is configured to instruct switch 132 to not allow the data packet into critical memory portion 126, and instead to deliver the non-critical data to non-critical memory portion 128. Partitioning memory 80 facilitates reserving a portion of memory 80 for critical function related data.

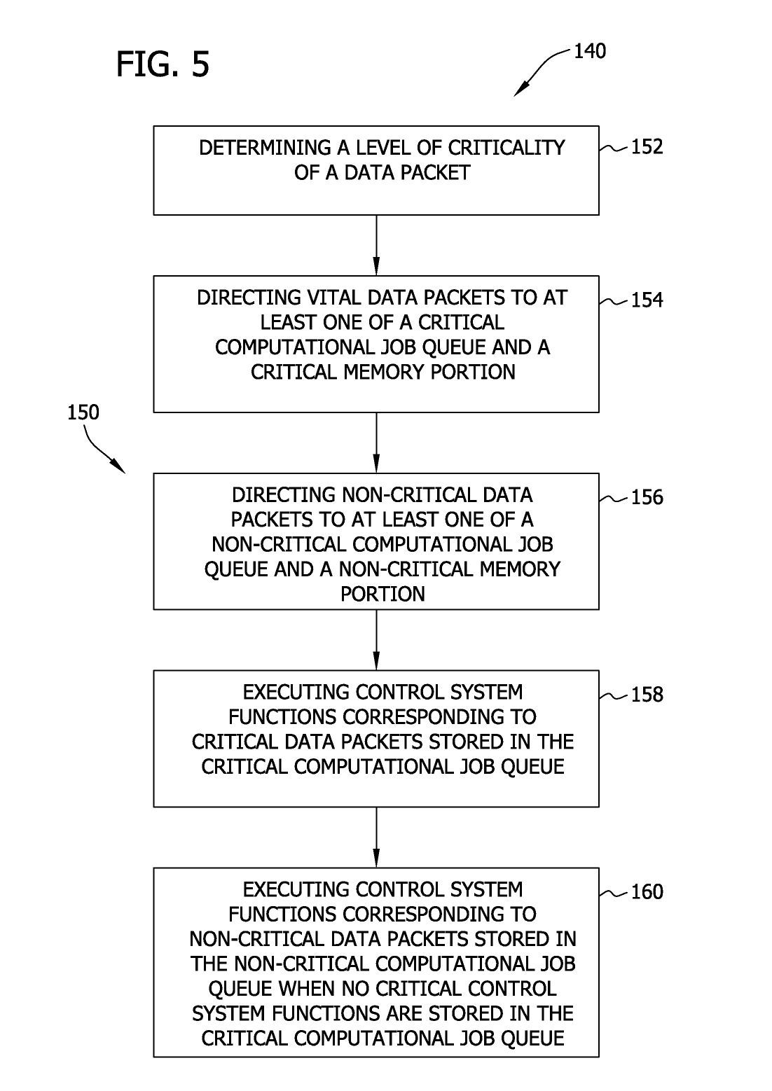

FIG. 5 is a flowchart 140 of an exemplary method 150 for processing critical control system functions. Method 150 includes determining 152 a level of criticality of a data packet. For example, critical function firewall 62 (shown in FIG. 5) determines 152 if a data packet received from communication bus 64 (shown in FIG. 2) is a critical, or a non-critical data packet. As described above, a critical data packet may include a request that processor 82 (shown in FIG. 4) execute a critical computational job or a request to input critical data into memory 80 (shown in FIG. 4). In some embodiments, determining 152 the level of criticality of a data packet includes extracting criticality data from a header field of the data packet.

Method 150 also includes directing 154 critical data packets to at least one of a critical computational job queue and a critical memory portion. For example, if critical function firewall 62 determines 152 that a data packet is a critical data packet that includes a request that processor 82 (shown in FIG. 4) execute a critical computational job, critical function firewall 62 directs 154 the data packet to critical computational job queue 120 (shown in FIG. 4). In another example, if critical function firewall 62 determines 152 that a data packet is a critical data packet that includes a request to input critical data into memory 80 (shown in FIG. 4), critical function firewall 62 directs 154 the data packet to memory 80, and instructs firewall switch 132 (shown in FIG. 4) to allow the data packet into critical memory portion 126.

Method 150 also includes directing 156 non-critical data packets to at least one of a non-critical computational job queue and a non-critical memory portion. For example, if critical function firewall 62 determines 152 that a data packet is a non-critical data packet that includes a request that processor 82 (shown in FIG. 4) execute a non-critical computational job, critical function firewall 62 directs 156 the data packet to non-critical computational job queue 122 (shown in FIG. 4). In another example, if critical function firewall 62 determines 152 that a data packet is a non-critical data packet that includes a request to input non-critical data into memory 80 (shown in FIG. 4), critical function firewall 62 directs 156 the data packet to memory 80, and instructs firewall switch 132 (shown in FIG. 4) not to allow the data packet into critical memory portion 126, but into non-critical memory portion 128 instead.

Method 150 also includes executing 158 control system functions corresponding to the critical data packets, and executing 160 control system functions corresponding to non-critical data packets stored in the non-critical computational job queue when no critical control system functions are stored in the critical computational job queue. In an exemplary embodiment, processor 82 (shown in FIG. 4) is configured to check critical job queue 120 for jobs, and execute 158 critical jobs prior to checking non-critical job queue 122. Critical function firewall 62 facilitates executing critical jobs prior to executing non-critical jobs.

The systems and methods described herein facilitate efficient and economical operation of a train control system. Facilitating separation of critical and non-critical functions, without additional hardware such as a second processor, facilitates including critical functions and large volumes of system software within the train control system in a cost effective manner. A technical effect of the methods and systems described herein includes facilitating separation of critical and non-critical functions within a train control system. By not requiring an additional system processor for critical functionality, the approach allows for cost effective inclusion of critical functions and large volumes of system software within the control system.

Although the systems and methods described and/or illustrated herein are described and/or illustrated with respect to train control systems, practice of the systems and methods described and/or illustrated herein is not limited to train control systems. Rather, the systems and methods described and/or illustrated herein are applicable to any vehicle having a control system and both critical and non-critical functions.

Exemplary embodiments of systems and methods are described and/or illustrated herein in detail. The systems and methods are not limited to the specific embodiments described herein, but rather, components of each system, as well as steps of each method, may be utilized independently and separately from other components and steps described herein. Each component, and each method step, can also be used in combination with other components and/or method steps.

The term processor, as used herein, refers to central processing units, microprocessors, microcontrollers, reduced instruction set circuits (RISC), application specific integrated circuits (ASIC), logic circuits, personal computers (PCs), field programmable gate arrays (FPGAs), and any other circuit or processor capable of executing the functions described herein.

Methods and systems described above limit the scope of interaction of algorithms and inputs on computational platforms by computation resource management that may be implemented in hardware and/or in software. This resource management facilitates reserving processor utilization MIPS for computation resource management functions, reserving a portion of a memory for critical functions, and reserving access to the portion of the memory reserved for critical functions to critical functions only. Inputs and outputs are message based with acknowledgment required, or of a failsafe hardware design for critical sensors or actuators.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for processing critical control system functions, said method comprising:
determining a level of criticality of at least one data packet;
directing critical data packets to at least one of a critical computational job queue and a critical memory portion;
directing non-critical data packets to at least one of a non-critical computational job queue and a non-critical memory portion;
executing control system functions corresponding to critical data packets stored in the critical computational job queue; and
executing control system functions corresponding to non-critical data packets stored in the non-critical computational job queue when no critical control system functions are stored in the critical computational job queue.

2. A method in accordance with claim 1 further comprising reserving the critical memory portion for critical data packets.

3. A method in accordance with claim 1 further comprising interrupting execution of a control system function corresponding to a non-critical data packet when a control system function corresponding to a critical data packet is received in the critical computational job queue.

4. A method in accordance with claim 1, wherein determining the level of criticality of at least one data packet comprises determining whether each of the at least one data packets is critical or non-critical.

5. A method in accordance with claim 1, wherein determining the level of criticality of at least one data packet comprises extracting criticality data from a header field of each of the at least one data packets.

6. A method in accordance with claim 1, wherein directing critical data packets comprises:
directing requests for critical computational jobs to the critical computational job queue; and
directing requests to input critical data into a computer memory to the critical memory portion.

7. A method in accordance with claim 1, wherein directing non-critical data packets comprises:
directing requests for non-critical computational jobs to the non-critical computational job queue; and
directing requests to input non-critical data into a computer memory to the non-critical memory portion.

8. A vehicle control system comprising:
at least one module coupled to a communication bus, said at least one module configured to generate data packets and transmit the data packets onto said communication bus;
a critical function firewall coupled to said communication bus, said critical function firewall configured to:
determine a level of criticality of requests contained in each data packet received from said communication bus, and direct each data packet according to the level of criticality; and
a computer system coupled to said critical function firewall and configured to process each data packet in accordance with the corresponding level of criticality.

9. A vehicle control system in accordance with claim 8, wherein said critical function firewall comprises a critical computational job queue and a non-critical computational job queue, wherein said critical computational job queue stores requests for critical computational jobs and said non-critical computational job queue stores requests for non-critical computational jobs.

10. A vehicle control system in accordance with claim 9, wherein said computer system is configured to:
execute requests for critical computational jobs stored in said critical computational job queue; and
execute requests for non-critical computational jobs stored in said non-critical computational job queue when no requests for critical computational jobs are stored in said critical computational job queue.

11. A vehicle control system in accordance with claim 9, wherein said computer system is configured to interrupt execution of a non-critical computational job when a critical computational job is received in said critical computational job queue.

12. A vehicle control system in accordance with claim 8, wherein said computer system comprises a memory unit and a processor.

13. A vehicle control system in accordance with claim 12, wherein said memory unit comprises at least two memory portions, a first memory portion configured to store critical data packets, and a second memory portion configured to store non-critical data packets.

14. A vehicle control system in accordance with claim 8, wherein said critical function firewall is implemented with at least one of a hardware component and a software code.

15. A critical function management system for managing critical functions of a vehicle control system, said critical function management system comprising:
a computer system comprising a memory unit and a processor, said memory unit comprising a first memory portion and a second memory portion; and
a critical function firewall coupled between a communication bus and said computer system, said critical function firewall configured to:
determine a criticality of received data packets,
direct requests to input critical data into said memory unit to said first memory portion, and
store requests for critical computational jobs in a critical computational job queue.

16. A critical function management system in accordance with claim 15, wherein said critical function firewall is further configured to at least one of:
direct requests to input non-critical data into said memory unit to said second memory portion, and
store requests for non-critical computational jobs in a non-critical computational job queue.

17. A critical function management system in accordance with claim 16, wherein said processor is configured to execute computational jobs in said critical computational job queue before executing computational jobs in said non-critical computational job queue.

18. A critical function management system in accordance with claim 17, wherein said processor is further configured to interrupt execution of a non-critical computational job when said critical function firewall stores a critical computational job in said critical computational job queue.

19. A critical function management system in accordance with claim 15, wherein said critical function firewall is further configured to prevent non-critical data packets from being stored in said first memory portion.

20. A critical function management system in accordance with claim 15, wherein said critical function firewall is implemented with at least one of a hardware component and a software code.
